(19) United States
(12) Patent Application Publication
(10) Pub. No.: US 2026/0178299 A1
(43) Pub. Date: Jun. 25, 2026

(54) APPLICATION DEPLOYMENT PLATFORM SYSTEMS, METHODS, AND DEVICES

(71) Applicant: HSBC SOFTWARE DEVELOPMENT (INDIA) PRIVATE LIMITED, Hyderabad (IN)

(72) Inventors: Amar Nath ETTA, Hyderabad (IN); Anuga REDDY, Hyderabad (IN); Aravind ALLAMNENI, Chandanagar (IN); Atharva Paresh RAJADHYAKSHA, Pune (IN); Chittaranjan BHIDE, Pune (IN); Murali Krishna Reddy GORREPATI, Hyderabad (IN); Sathya Suhasini KATTEBOINA, Hyderabad (IN); Shailesh PATEL, Hyderabad (IN); Shrikant VADAPALLI, Hyderabad (IN); Vamsi Krishna VENNELA, Hyderabad (IN)

(21) Appl. No.: 19/050,212

(22) Filed: Feb. 11, 2025

(30) Foreign Application Priority Data
Dec. 20, 2024 (IN) 202441101443

(51) Int. Cl. G06F 8/60; G06F 9/54; H04L 9/40

(52) U.S. Cl. CPC G06F 8/60; G06F 9/547; H04L 63/083

(57) ABSTRACT

Systems, methods, and devices disclosed herein include an application deployment platform comprising a web client application, a backend control system, and a backend migration system. The web client application provides a graphical user interface (GUI) configured to receive one or more user inputs identifying a target application and a plurality of deployment parameters for the target application. The backend control system is integrated with a cloud workflow management platform API, an issue tracking platform API, a source data analytics and management platform API, and a developer platform API. Also, the backend control system performs one or more verification operations including determining whether the one or more user inputs are associated with an IT personnel or a business unit personnel. Furthermore, the backend migration system is configured to migrate the target application from a developer platform associated with the developer platform API to a destination environment.

### CROSS-REFERENCE TO RELATED APPLICATIONS

This application claims priority to the and the benefit of Indian Patent Application No. 202441101443, filed Dec. 20, 2024, the contents for which is incorporated into the present application by reference.

### BACKGROUND

Typically, when a business internally deploys a new application, their IT department must perform multiple tests and deployment verification procedures to ensure the new application will function properly. This can be time consuming and expensive, especially for applications that require multiple version updates on a regular basis.

It is with these observations in mind, among others, that various aspects of the present disclosure were conceived and developed.

### SUMMARY

Systems, methods, and devices disclosed herein can address the aforementioned issues. For instance, an application deployment platform can include a web client application providing a graphical user interface (GUI) configured to receive one or more user inputs identifying a target application and a plurality of deployment parameters for the target application. The application deployment platform can include a backend control system integrated with a cloud workflow management platform API, an issue tracking platform API, a source data analytics and management platform API, and/or a developer platform API. The backend control system can perform one or more verification operations including determining whether the one or more user inputs are associated with an IT personnel or a business unit personnel. Additionally, the application deployment platform can include a backend migration system configured, responsive to completion of the one or more verification operations by the backend control system, to migrate the target application from a developer platform associated with the developer platform API to a destination environment.

In some examples, the GUI can include an environment selection prompt and an application movement prompt. Additionally, the migrating of the target application can include sending a QVF file without data to the destination environment. Also, the one or more verification operations can include checking, based on a determination of a type of user, whether a change request number associated with the IT personnel is valid, and/or checking whether a Jira ticket number associated with the business unit personnel is valid. Furthermore, the target application can include a dashboard template. Moreover, the plurality of deployment parameters indicated by the one or more user inputs can include at least one of a source stream, a source application, a destination stream, or a destination application.

In some scenarios, the backend control system can determine that the one or more user inputs are associated with the IT personnel and, in response, can send an API request to the cloud workflow management platform API. Additionally or alternatively, the backend control system can determine that the one or more user inputs are associated with the business unit personnel and, in response, can send an API request to the cloud workflow management platform API. Also, the backend control system can be configured, responsive to receiving the plurality of deployment parameters, to send a query to a source data analytics and management server associated with the source data analytics and management platform API, for a list of streams for which a user associated with the one or more user inputs is authorized. Moreover, the backend control system can be configured, responsive to receiving the plurality of deployment parameters, to send a query to a source data analytics and management server for a list of streams for which a user associated with the one or more user inputs is authorized.

In some instances, an application deployment platform can include a web client application providing a GUI configured to receive one or more user inputs identifying a target application and a plurality of deployment parameters for the target application. The plurality of deployment parameters can include an indication of at least one of a source application, a source stream, a destination application, or a destination stream. The application deployment platform can also include a backend control system integrated with a cloud workflow management platform API, an issue tracking platform API, a source data analytics and management platform API, and a developer platform API. The backend control system can perform one or more verification operations including determining whether the one or more user inputs are associated with a user authorized to access the source application, the source stream, the destination application, or the destination stream. Furthermore, the application deployment platform can include a backend migration system configured, responsive to completion of the one or more verification operations by the backend control system, to migrate the target application from a developer platform associated with the developer platform API to a destination environment.

In some examples, the migrating of the target application can include identifying a previously uploaded application in the destination environment and replacing the previously uploaded application with the target application. Additionally, the backend control system can be configured to convert a plurality of responses from the source data analytics and management platform API from a plurality of JSON data files to a plurality of pandas data frame files. Also, the application deployment platform can include a vectorization search performed on the plurality of pandas data frame files. Furthermore, the application deployment platform can include a token-based authentication between the web client application and the developer platform API. The backend control system can be configured to receive a fail or error message in response to an API request sent to the cloud workflow management platform API or the developer platform API. Also, responsive to the fail or error message, the backend control system can be configured to queue the API request for a retry.

In some scenarios, a method of deploying an application using an application deployment platform can include receiving, at a GUI of a web client application, one or more user inputs identifying a target application and a plurality of deployment parameters for the target application. The method can also include integrating a backend control system with a cloud workflow management platform API, an issue tracking platform API, a source data analytics and management platform API, and/or a developer platform API. The method can also include performing one or more verification operations, based on the plurality of deployment parameters, and using a plurality of communications between the backend control system and the cloud workflow management platform API, the issue tracking platform API, the source data analytics and management platform API, or the developer platform API. The method can also include, responsive to completion of the one or more verification operations, migrating, using a backend migration system, the target application from a developer platform associated with the developer platform API to a destination environment.

In some instances, the plurality of deployment parameters can include one or more indications of a source application, a source stream, a destination application, or a destination stream. Furthermore, the one or more verification operations can include determining whether a user associated with the one or more user inputs is authorized to access the source application, the source stream, the destination application, and/or the destination stream. Also, the one or more verification operations can include determining whether the one or more user inputs are associated with an IT personnel or a business unit personnel. Moreover, the method can include presenting, at the GUI a first selectable interface element configured to receive a first user input indicating a deployment environment; a second selectable interface element configured to receive a second user input indicating a source server; a third selectable interface element configured to receive a third user input indicating a destination server; a fourth selectable interface element configured to receive a fourth user input indicating a source stream; and/or a fifth selectable interface element configured to receive a fifth user input indicating a destination stream.

### BRIEF DESCRIPTION OF THE FIGURES

FIG. 1 illustrates an example system including an application deployment platform.

FIG. 2A illustrates an example system including an application deployment platform having a web client application in communication with a backend control system.

FIG. 2B illustrates an example system including an application deployment platform having a backend control system in communication with a source data analytics server.

FIG. 2C illustrates an example system including an application deployment platform having a backend migration system in communication with a version control system.

FIG. 3 illustrates an example system including an application deployment platform having a workflow procedure.

FIG. 4 illustrates an example system including an application deployment platform having a computational architecture.

FIGS. 5A and 5B illustrate an example system including an application deployment platform having a physical hardware infrastructure.

FIG. 6 illustrates an example system including an application deployment platform having a graphical user interface configuration with a plurality of selectable interface elements.

FIG. 7 illustrates an example system including an application deployment platform having a graphical user interface configuration with an application movement prompt.

FIG. 8 illustrates an example system including an application deployment platform having a developer platform interface.

FIG. 9 illustrates an example system including an application deployment platform implemented in a networked environment.

FIG. 10 illustrates an example method of deploying one or more applications using an application deployment platform, which can be performed by any of the systems depicted in FIGS. 1-9.

### DETAILED DESCRIPTION

It will be appreciated that numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts may be exaggerated to better illustrate details and features of the present disclosure.

The systems, methods, and devices disclosed herein can include an application deployment platform (e.g., “SenseFast”). The application deployment platform can help users manage and deploy their own applications quickly and independently as a self-service, which can eliminate and/or reduce dependency on an IT admin team. Moreover, the application deployment platform can deploy application(s) securely by following the institutional change management processes of on-premises services and/or cloud services.

In some examples, the technology disclosed herein can provide faster deployments. For instance, the application deployment platform can reduce an amount of time taken for application deployment by 90% and/or can save 30 minutes or more for each application deployment. Additionally, the disclosed technology can be used for concurrent application deployments. For examples, users can use the application deployment platform to deploy multiple applications with a single click. This may not be possible using previous systems because admin personnel may sometimes be needed to perform manual deployments in a sequential order. Using the disclosed technology, there may be no limitations on the number of concurrent deployments performed without involving additional IT personnel.

Additionally, in some scenarios, the disclosed technology can result in cost savings, for instance by reducing an overall IT cost by ˜30%. The application deployment platform can also include version control protocols. Applications can be copied to an external developer platform (e.g., GitHub) without data (e.g., as a template) to provide the version control. Also, the application deployment platform can include an auto application refresh system. For example, post deployment of applications to a destination environment, applications can be auto refreshed with latest data for user's usage. Furthermore, the disclosed technology can include a change management system, which can include integration of the application deployment platform with an external cloud workflow management platform API (e.g., ServiceNow API) to validate all deployment requests and/or to follow an institutional change management process. The disclosed systems can also include a notification system such that application deployment status can be notified to required users with logs. Accordingly, the technology disclosed herein can be used for self service deployments and/or on-demand deployments based on a user needs at any time without needing additional IT personnel involvement.

In some examples, the application deployment platform can provide users the flexibility to deploy applications on-demand without any dependency on admin team, all while following the required security and change management process of the institution implementing the platform (e.g., financial services institutions, banking institutions, so forth). The application deployment platform can use an active directory authentication mechanism to ensure that users are able to view and manage only those applications to which they have been given access. Additionally, users can monitor the live deployment status of the application(s) using a logging mechanism presented on a web interface. Admin personal can monitor and track user's deployment usage, which can be useful for audit purpose. As such, the service-based catalogue through a web interface can make application deployments available by selecting multiple apps for deployment with just a click. This can overcome the manual deployment challenges faced by admin teams, and can provide self-service, on-demand deployment of applications between multiple environments, with version control and change management mechanisms in place, as well.

Furthermore, the systems disclosed herein can provide an open source solution via integration with an external developer platform (e.g., GitHub), such that engineering teams across the institution/business deploying the system can adopt and enhance the solution. Additionally or alternatively, the system can include a centralized solution, which can help multiple environments adopt the tool with serverless capability. Furthermore, the disclosed technology can result in faster deployments, version controls, auto refresh, control validation, and/or immediate use of applications, leading customers to use the deployed application within fractions of minute.

In some examples, the system can be implemented with one time setup, no platform admin intervention for deployment, and an “always on” configuration. As such, the disclosed system can meet rapidly changing customer needs. The system can include zero costs, and can be entirely or partially open source. Furthermore, the disclosed application deployment platform can include various self-learning protocols, and can enhance the user's experience while eliminating and/or reducing human error, resulting in improved efficiency. Additionally, the application deployment platform can provide a service-based catalogue with a user interface to manage application deployment for on-premises services and/or cloud services.

Additional advantages of the disclosed technology will become apparent from the detailed description below.

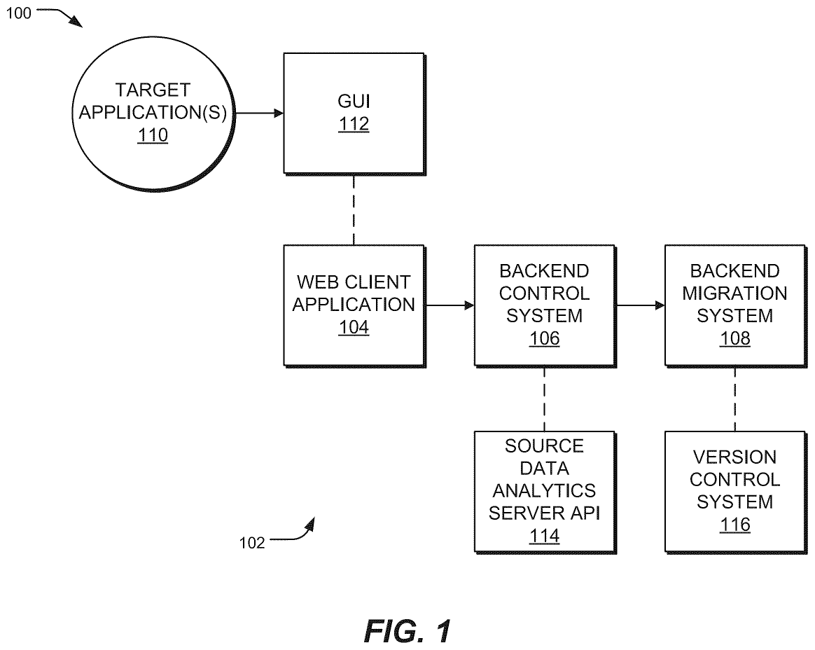

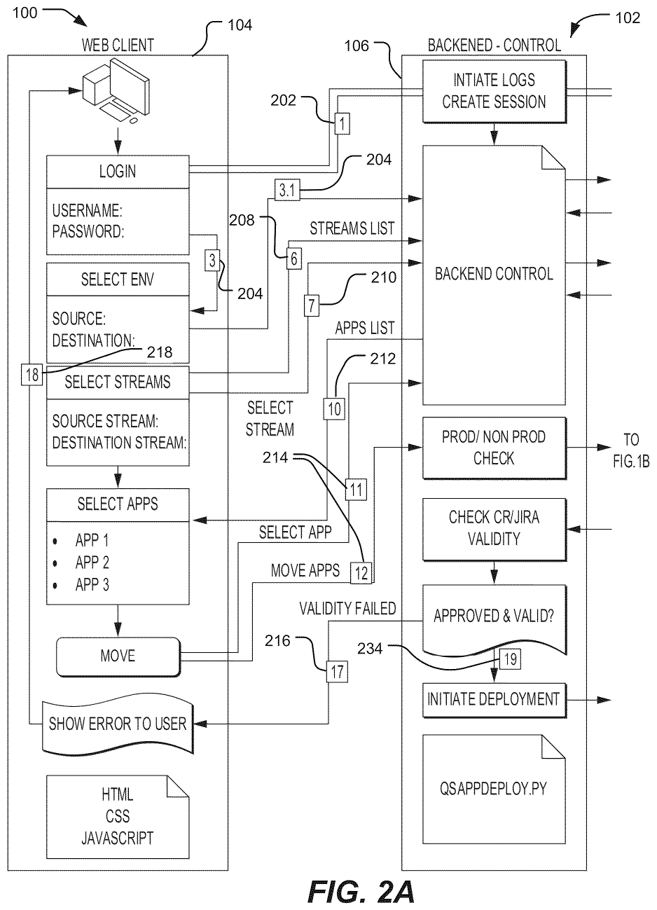

FIG. 1 illustrates an example system 100 including an application deployment platform 102.

In some examples, the application deployment platform 102 includes multiple, inter-operable components for providing the services disclosed herein. For instance, the application deployment platform 102 can include a web client application 104, a back end control system 106, and/or a backend migration system 108.

In some instances, the web client application 104 can be an interactive webapp for selecting one or more target application(s) 110 for migration and initiating the migration. The web client application 104 can include a graphical user interface (GUI) 112 for receiving one or more user inputs which select the target application(s) 110. Furthermore, the GUI 112 can receive user input(s) for determining parameters of the target application(s) 110 and/or the deployment procedure disclosed herein. Additionally, the backend control system 106 can perform operations to verify the constraints and checks, such as the user's authorization to access streams and applications (e.g., Prod/Non-Prod, CR/Jira Validity). The backend control system 108 can include and/or interact with a source data analytics and management server API 114 (e.g., a Source Qlik Sense Server API). Moreover, the backend migration system 108 can perform operations to initiate the migration of the target application(s) 110 from the source environment to the destination environment. The backend migration system 108 can include and/or interact with a version control system 116

In some examples, one time cyber checks can be performed by the application deployment platform 102, and any issues can be reported. Also, the application deployment platform 102 can be developed on python. A python deployment script can be placed in a non-production environment. Additionally, users can provide an external issue tracking platform (e.g., Jira) and/or administrators with a commercial registration (CR) number, and can implement a group for validation. If a change management process is successful, entitled applications can be viewable on the GUI 112, and a user can provide an input to select one or more designated streams and/or dashboards.

In some instances, the system 100 can provide a hosted web interface (e.g., the web client application 104) to make a connection with a non-production server with help from one or more python packages. A script can export the dashboards to the external developer platform (e.g., GitHub) directly in a stream-wise structure on the external developer platform. From the external developer platform, the dashboards can be imported to a production server and can be published and/or replaced. Additionally, using the disclosed techniques, the dashboards can be reloaded automatically. A status of the application deployment can displayed on the GUI 112. Also, infrastructure technology, such as Windows IIS Systems, can be used by the system(s) 100 disclosed herein. The version control system 116 can include GIT Repositories. Additionally, the application deployment platform 102 can be developed using the Lang python programming module. Moreover, on-premises services and/or cloud services of the application deployment platform 102 can be implemented on one or more Windows server(s). Additional details of the application deployment platform 102 are discussed below.

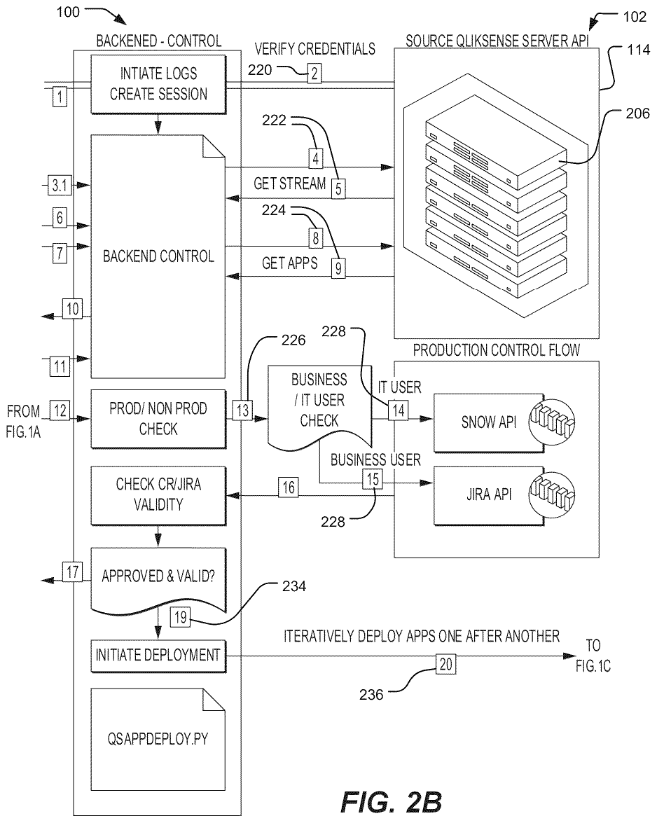

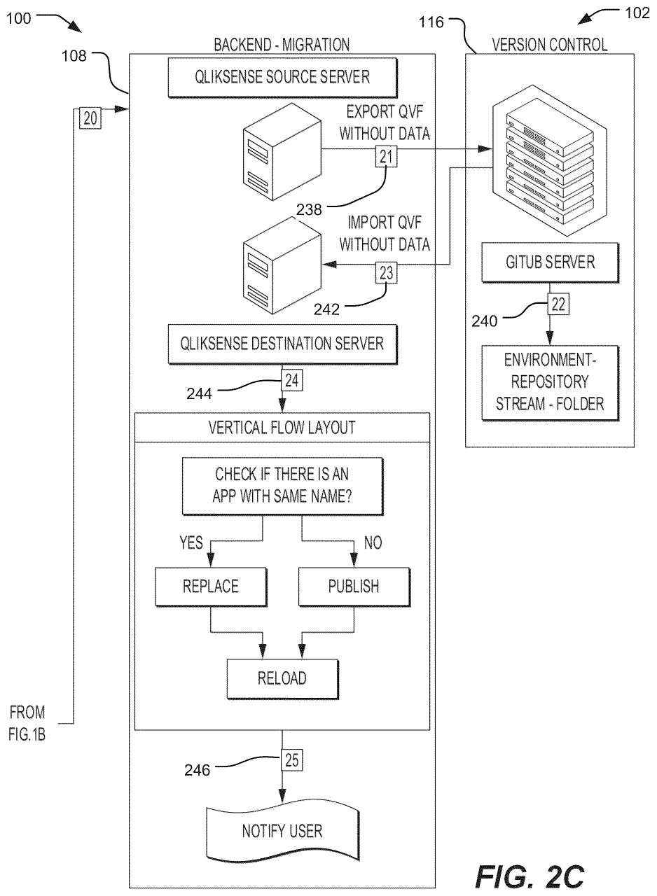

FIG. 2A illustrates an example system 100 including communications between the web web client application 104 and the backend control system 106. The system(s) 100 depicted in FIG. 2A can be similar to, identical to, and/or can form at least a portion of the system(s) 100 shown in FIG. 1.

In some instances, web client application 104 (e.g., “SenseFast webapp”) can be the point of interaction for both IT and Business users. The web application client 104 can enable the user to make necessary selections to migrate apps between Development, User Acceptance Testing, and Production (DEV/UAT/PROD) environments. The application deployment platform 102 can use the web client application 104 to perform a first data operation 202 (e.g., “Step 1”) in which the user first enters their Username and AD password into the homepage of the web client application 104. Then the web client application 104 can perform one or more second data operation(s) 204 (e.g., “Steps 3, 3.1”) in which the user is prompted to select the source and destination servers for app migration (e.g. Dev to UAT, UAT to Prod, and/or combinations thereof). The web client application 104 can receive one or more selection inputs from the user at the GUI 112 as part of the second data operation(s) 204. Once selected, a query can be sent to a selected source server 206 (e.g., a “Qlik Sense source sever” or a stream access server) to get a list of streams. Source and destination servers can be restricted based on credentials provided during a login operation, such that only those servers the credentials are authorized to see will be presented.

In some examples, the web client application 104 can perform a third data operation 208 (e.g., “Step 6”) in which a list of streams is displayed for the user to select the source stream(s) and/or the destination stream(s), for instance, at the GUI 112. The web client application 104 can perform a fourth data operation 210 (e.g., “Step 7”) in which selected source and destination stream names are sent to the backend control system 106. Additionally, the web client application 104 can perform a fifth data operation 212 (e.g., “Step 10”) in which an applications list from the selected stream is displayed for the user to select the target applications 110 to be migrated (e.g., via an input at the GUI 112). The web client application 104 can also perform one or more sixth data operation(s) 214 (e.g. “Steps 11, 12”) in which the user can submit the applications to be moved, and in response, a request can be sent to the backend control system 106 to initiate migration and check for production movement. If the destination is PROD (e.g., production), users can be prompted to enter a ticket number (e.g., a Jira ticket number), and/or a Change Request Number (CR) based on whether the user is from a Business unit or an IT unit, respectively. Furthermore, the web client application 104 can perform a seventh data operation 216 (e.g., “Step 17”) if the validation of CR or Jira fails, in which an error code is shown to the user (e.g., at the GUI 112). Moreover, the web client application 104 can perform an eight data operation 218 (e.g., “Step 18”) in which the user is sent back to a home screen (e.g., of the GUI 112).

FIG. 2B illustrates an example system 100 including communications between the backend control system 106 and the source data analytics and management server API 114. Furthermore, the communications depicted in FIG. 2B can include one or more data operations between then backend control system 106 and the backend migration system 108. The system(s) 100 depicted in FIG. 2B can be similar to, identical to, and/or can form at least a portion of the system(s) 100 shown in FIG. 1.

In some examples, the backend control system 106 can be the main control plane of the application deployment platform 102. The backend control system 106 can interact with the user via the web client application 104 and can integrate with the external cloud workflow management platform API (e.g., the ServiceNow API) and the external issue tracking platform API (e.g., the Jira API). This control plane can also interact with the source data analytics and management server API 114 (e.g., the Qlik Sense API) to push applications to the external developer platform (e.g., GitHub).

In some scenarios, the backend control system 106 can perform a first data operation 220 (e.g., “Step 2”) in which the username and password are used in the backend to check whether the user is authorized to access various streams and apps. The backend control system 106 can perform one or more second data operation(s) 222 (e.g., “Steps 4, 5”) once the source and destination environments are selected, in which the backend control system 106 queries the source server 206 (e.g., the Qlik Sense server) to get a list of all the streams the user is authorized to access. Furthermore, the backend control system 106 can perform one or more third data operation(s) 224 (e.g., “Steps 8, 9”) once streams are selected, in which the backend control system 106 queries the source server 206 (e.g., the Qlik Sense server) to get a list of all the applications in the source stream.

In some instances, the backend control system 106 can perform a fourth data operation 226 (e.g., “Step 13”) in which the backend control system 106 checks if the user has a status as an IT unit user or business unit user (e.g., by checking one or more databases storing such information, and/or by prompting the user to provide user input). In response, the backend control system 106 can perform one or more fifth data operation(s) 228 (e.g., “Steps 14, 15”) by sending an API request to the external cloud workflow management platform API (e.g., ServiceNow API, at Step 14) if the user is an IT unit user, or to the external issue tracking platform API (e.g., Jira API, at Step 15) to verify the validity of the given CR or ticket number (e.g., Jira ID). The backend control system 106 can, at the fifth data operation(s) 228 (e.g., “Step 14”) check if the CR is approved and is in the valid CR window. All change requests can require a ticket and the application deployment platform 102 can require the ticket number and can verify the ticket was raised within the past 24 hours. If the change request ticket is older than 24 hours (e.g., or some other predetermined time threshold), the change request may raise an error message and a new ticket may need to be obtained. This can be an internal change request management control specific to the institution deploying the system 100. Additionally, the backend control system 106 can, at the fifth data operation(s) 228 (e.g., “Step 15”), check if the Jira ID is valid. Migration can be implemented only if the Jira or the CR are valid. Moreover, the backend control system 106 can perform a sixth data operation 234 (e.g., “Step 19”) responsive to successful validation, including initiating migration with a request to the backend migration system 108, and/or iterative requests as a seventh data operation 236 (e.g., “Step 20”).

FIG. 2C illustrates an example system 100 including communications between the backend migration system 108 and the version control system 116. Furthermore, the communications depicted in FIG. 2C can include one or more data operations between the backend control system 106 and the backend migration system 108. The system(s) 100 depicted in FIG. 2C can be similar to, identical to, and/or can form at least a portion of the system(s) 100 shown in FIG. 1.

In some examples, the backend control system 106 can reach the backend migration system 108 once all the validations are complete, and the target application(s) 110 are ready to be moved. This plane can repeatedly execute the same sequence of steps for each of the target application(s) 110 to be migrated (e.g., in an iterative manner).

In some examples, the backend migration system 108 can perform a first data operation 238 (e.g., “Step 21”) in which the target application 110 can be exported to the external developer platform (e.g., GitHub) as a QVF file without data. This can provide an isolation of development (DEV) data, User Acceptance Testing (UAT) data, and production (PROD) data. For instance, a template of a current version of the target application 110 from the relevant environment can be exported without data to the external developer platform (e.g., GitHub) and then, at step 23, the template can be imported to the stream on the destination server. The target application 110 can then be loaded using the template from the external developer platform and the data from the destination server environment. The first data operation 238 of the backend migration system 108 can be performed using one or more vector-based search(es). Additionally, the backend migration system 108 can perform a second data operation 240 (e.g., “Step 22”) in which the target application 110 in the external developer platform (e.g., GitHub) is moved to a particular repository based on the environment and a corresponding folder within the repository based on the stream.

Furthermore, in some scenarios, the backend migration system 108 can perform a third data operation 242 (e.g., “Step 23”) in which the target application 110 is imported from the external developer platform (e.g., GitHub) to the destination environment. Also, the backend migration system 108 can perform a fourth data operation 244 (e.g., “Step 24”) in which all the applications in the destination can be checked to see if there is an existing application in the destination stream with the same name as the target application 110, and is published or replaced accordingly. Moreover, the back end migration system 108 can perform one or more fifth data operation(s) 246 (e.g., “Step 25”) responsive to successfully migrating all of the target application(s) 110, in which the user can be shown a success message (e.g., at the GUI 112) and can be prompted to go to a logs user interface. Also, the fifth data operation(s) 246 can include creating streams on the DEV/UAT/PROD environments as part of onboarding process such that streams for the target application are available when using the tool.

In some examples, by integrating the web client application 104, the backend control system 106, and the backend migration system 108, as discussed herein, the application deployment platform 102 can implement a version control protocol, a backend control protocol, and/or a an application import/export protocol, as discussed in greater detail below.

For instance, the version control protocol can be used for integration with the external developer platform (e.g., GitHub). This can include storing a backup copy of the current dashboards prior to migration for rollback purposes and version control. Also, the version control protocol can use token-based authentication for more secure and faster authentication with the external developer platform (e.g., GitHub). Furthermore, the application deployment platform 102 can store QVFs of the target application(s) 110 organized into folders by stream and environment.

Furthermore, the backend control protocol of the application deployment platform 102 can include integration with the external workflow management platform API (e.g., the ServiceNow API). This can include using the Service Now (e.g., SNOW) API to check change request validity and CR window status before the migration as a control for production and pre-production environments. The backend control protocol can include using token-based authentication (e.g., instead of a username/password protocol) for faster and more secure access. The backend control protocol can also include Jira integration. For instance, the Jira integration can include a streamlined migration workflow by relaxing the CR requirement to a Jira ticket for business unit users. For instance, the Jira ticket number can be validated before migration. As such, the institution using the application deployment platform 102 can keep track of movements on Jira.

Additionally, the application import/export protocol of the application deployment platform 102 can include data analytics and management platform integration (e.g., Qlik Sense or “QRS API” integration). This can include permission management operations such that a user is only able to view and/or migrate the applications and streams to which the user has access. For instance, the application deployment platform 102 can check user permissions on streams and dashboards, and can initiate migrations and reloads of dashboards using the data analytics and management server API 114 (e.g., the Qlik Sense API (qrspy)). Furthermore, requests can be queued and retried (e.g., to the GitHub API, QRS API, and/or the SNOW API) to make the system 100 more resilient. Additionally, one or more JSON responses from the QRS API can be converted to a two-dimensional, size-mutable, and/or heterogeneous tabular data structure (e.g., a pandas data frame) for faster parsing and search.

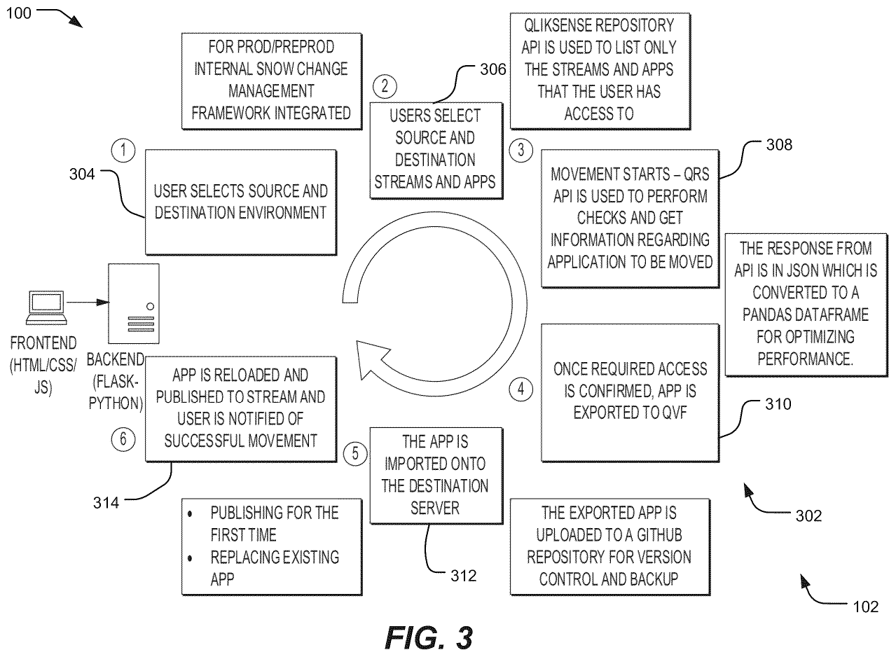

FIG. 3 depicts an example system 100 including the application deployment platform 102. As shown in FIG. 3, the application deployment platform 102 can include an iterative workflow procedure 302. The system(s) 100 depicted in FIG. 3 can be similar to, identical to, and/or can form at least a portion of the system(s) 100 shown in FIG. 1.

For example, the workflow procedure 302 can include a first operation 304 in which the user selects one or more source environments and/or one or more destination environments. At a second operation 306, the workflow procedure 302 can include the user selecting source streams, destination streams, source applications, destination applications, and/or any combination thereof. This can include using the Qlik Sense repository API to list only the streams and apps to which the user has access. At a third operation 308, the application movement can begin, in that the QRS API can be used to perform checks and get information regarding the target application 110 to be used. The response from the QRS API can be a JSON file, which can be converted to a pandas data frame to optimize performance. At a fourth operation 310, once the appropriate access for the user is confirmed, the target application 110 can be exported as a QVF data file. This exported application can be uploaded to a GitHub repository for version control and backup. At a fifth operation 312, the workflow procedure can include importing the QVF of the target application 110 onto the destination server. Moreover, the workflow procedure 302 can include a sixth operation 314 in which the target application is reloaded and published to the destination stream(s), and a user is notified of the successful application movement. This can include publishing the application for a first time or replacing a previously existing application. Furthermore, for production and/or pre-production scenarios, an internal Service Now Change Management Framework can be integrated into the application deployment platform 102 for implementing the workflow procedure 302.

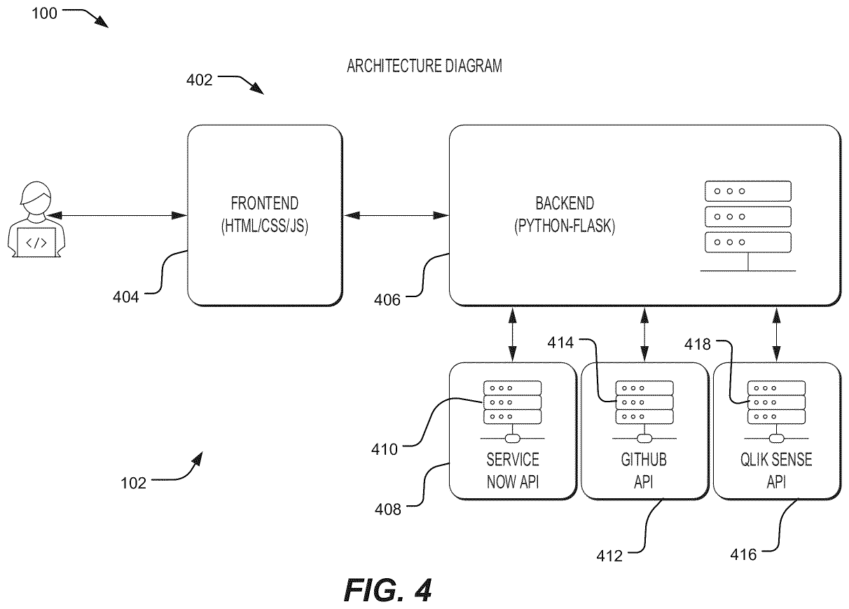

FIG. 4 depicts an example system 100 including the application deployment platform 102. As shown in FIG. 4, the application deployment platform 102 can include a computational architecture 402 for implementing the components and operations discussed herein. The system(s) 100 depicted in FIG. 4 can be similar to, identical to, and/or can form at least a portion of the system(s) 100 shown in FIG. 1.

In some examples, the computational architecture 402 can implement the workflow procedure 302 using a frontend 404 and a backend 406. The frontend 404 can include an HTML format, a CSS format, a JS format, and/or combinations thereof, for implementing the web application client 104. Additionally, the backend 406 can include a lightweight framework (e.g., Flask) in python. The backend 406 can include integration of a plurality of different APIs, each having a corresponding server. For instance, the backend 406 can include integration of the ServiceNow API 408 on a ServiceNow server 410, a GitHub API 412 on a GitHub server 414, and/or a Qlik Sense API 416 on a Qlik Sense server 418.

Furthermore, in some instances, the computational architecture 402 can include various optimizations to overcome particular challenges. For instance, the application deployment platform 102 can convert the Apps/Streams data from JSON to the pandas data frame, which can improved search performance by vectorization rather than linear search. Also, the Service Now and/or GitHub authentication can use token-based authentication (e.g., rather than username and password), which can improve security and response time from GitHub and Service Now servers. Furthermore, the application deployment platform 102 can improve reliability by handling failed requests and queuing them for retrying, which can improve fault tolerance(s) with Service Now and/or GitHub server responses. Furthermore, a bridge between the internet information services (IIS) and the web server gateway interface (WSGI) can be moved to a HttpPlatformHandler module to correctly handle long running http requests.

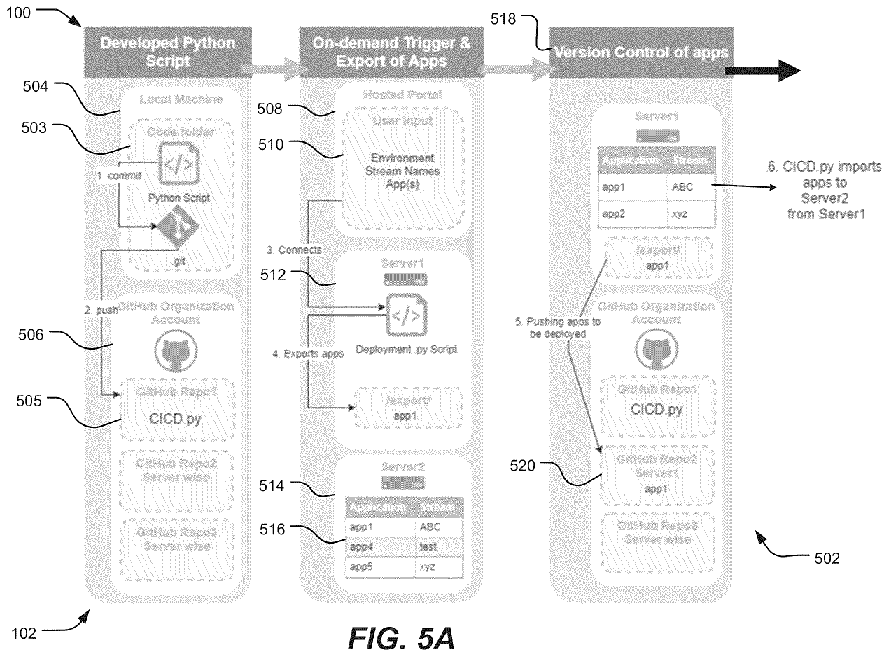

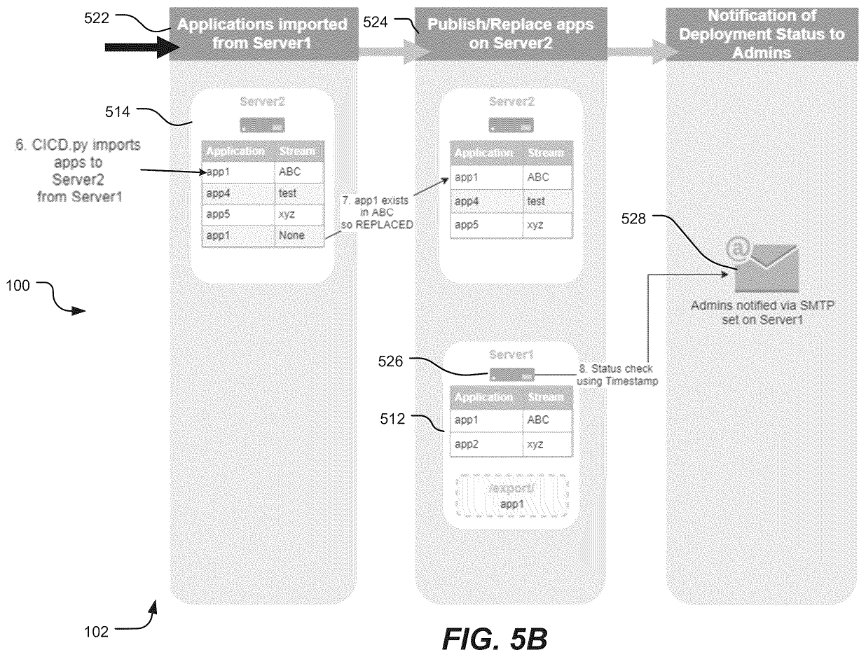

FIGS. 5A and 5B depict an example system 100 including the application deployment platform 102. As shown in FIGS. 5A and 5B, the application deployment platform 102 can be implemented an a physical hardware infrastructure 502. The system(s) 100 depicted in FIGS. 5A and 5B can be similar to, identical to, and/or can form at least a portion of the system(s) 100 shown in FIG. 1.

As shown in FIG. 5A, in some examples, the physical hardware infrastructure 502 can include a local machine 504 with a code directory 503 storing developed python script. Upon receiving a commit, the python script can be pushed to a first repository 505 of the GitHub Organization Account 506 (e.g., GitHub Repo1). On-demand trigger and export of applications can be implemented via a hosted portal 508 which receives the user inputs 510 discussed herein, and uses the environment stream names and apps names to connect to a first server 512 (e.g., of the GitHub Organization Account 506). A second server 514 can store one or more data objects 516 including associations between applications (e.g., application identifier strings) and streams (e.g., stream identifier strings). Moreover, as part of the version control protocol 518, the target application 110 can be imported to the first server 512, which can be associated with a second repository 520 of the GitHub Organization Account 506.

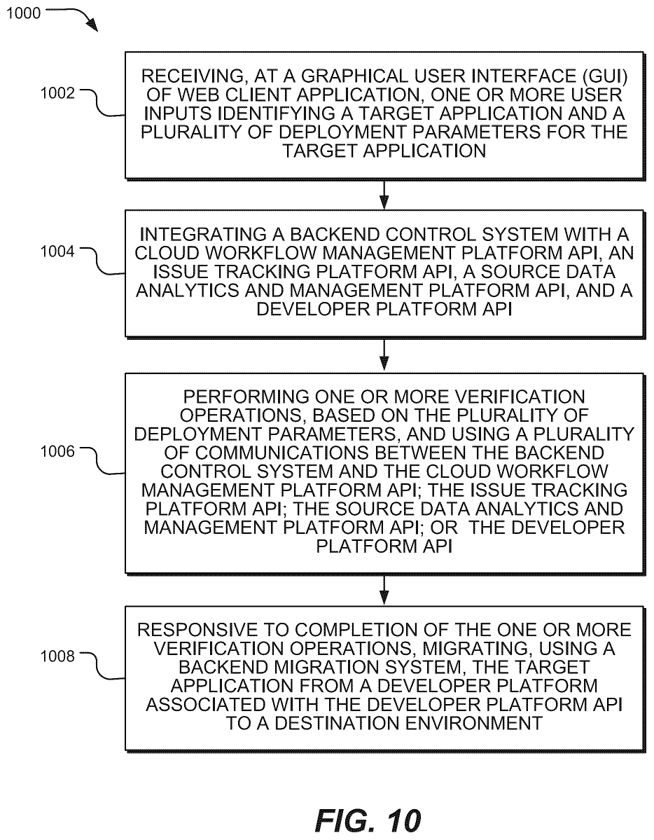

Turning to FIG. 5B, an importing procedure 522 can include importing the application to the second server 514 from the first server 512, Additionally, the system 100 can check if the application exists on the second server 514 associated with any streams and, if so, can cause the previously stored application to be replaced with the published application during a replacement operation 524. Additionally, a timestamp 526 stored at the first server 512 can be used to notify admins of a status check of the target application 110 after deployment using a Simple Mail Transfer Protocol (SMTP) 528 set on the first server 512. As discussed in greater detail below regarding FIG. 10, the physical hardware infrastructure 502 can include additional and/or alternative components or configurations to implement the application deployment platform 102 disclosed herein.

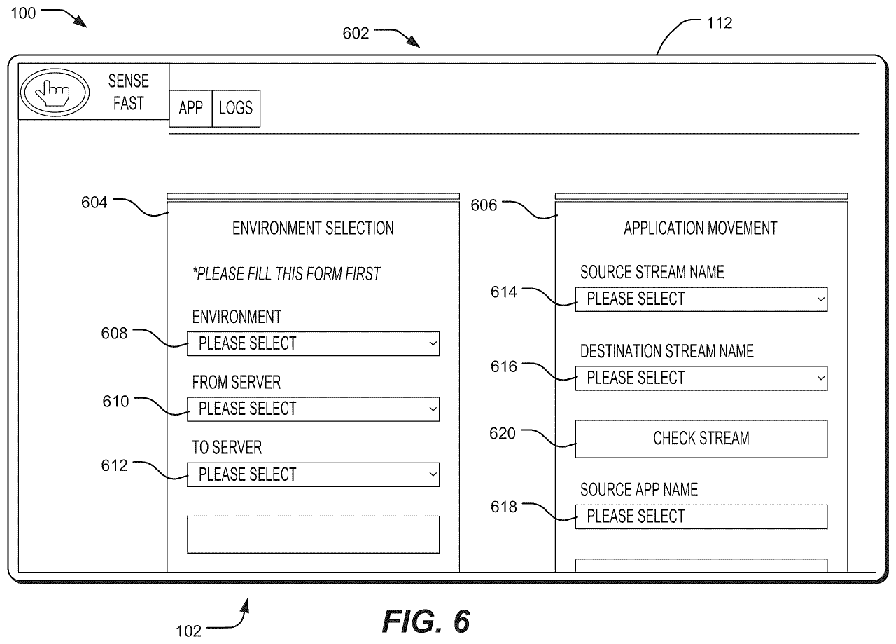

FIG. 6 depicts an example system 100 including the application deployment platform 102. As shown in FIG. 6, the application deployment platform 102 can include a GUI configuration 602 for implementing the components and operations discussed herein. The system(s) 100 depicted in FIG. 6 can be similar to, identical to, and/or can form at least a portion of the system(s) 100 shown in FIG. 1.

In some examples, the GUI configuration 602 can be presented at the GUI 112 of the web client application 104 for receiving indications for a plurality of deployment parameters. The GUI configuration 602 can include an environment selection prompt 604 and/or an application movement prompt 606 The environment selection prompt 604 can include first selectable interface element 608 for receiving a first user input indicating in which environment(s) the application deployments will occur. Also, the environment selection prompt 604 can include a second selectable interface element 610 for receiving a second user input indicating from which server the application will be deployed, and a third selectable interface element 612 for receiving a third user input which determines the server to which the application will be deployed.

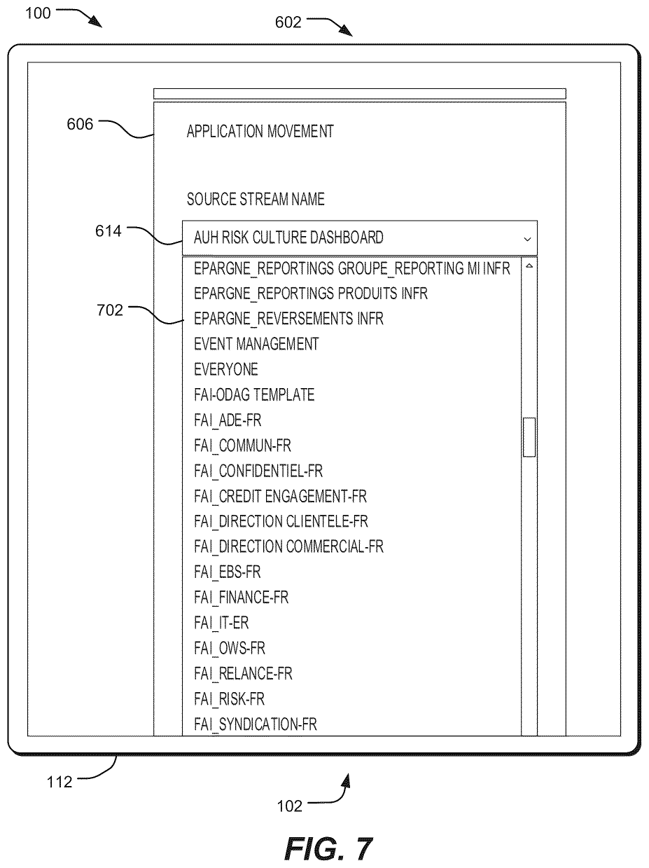

Furthermore, in some scenarios, the application movement prompt 606 can include a fourth selectable interface element 614 for receiving a fourth user input determining a source stream name for the target application 110. Additionally, the application movement prompt 606 can include a fifth selectable interface element 616 for receiving a fifth user input indicating a destination stream name for the target application. Also, a sixth selectable interface element 618 can receive a sixth user input selecting the source application name. Moreover, a seventh selectable interface element 620 can receive an input to initiate a stream check for the streams selected at the fourth selectable interface element 614 and/or the fifth selectable interface element 616. Any of the first selectable interface element 608, the second selectable interface element 610, the third selectable interface element 612, the fourth selectable interface element 614, the fifth selectable interface element 616, and/or the sixth selectable interface element 618 can comprise a drop down menu, an icon, a check box, a text field, a link, and/or any combinations thereof. Turning to FIG. 7, the fourth selectable interface element 614 can include a drop down menu 702 for selecting the source stream for the target application 110. The drop down menu 702 can list every stream available for selection by the user, for instance in alphabetical order and/or with a side scroll bar. These can include streams related to group reporting, product reporting, reversements, event management, everyone, templates, confidential data, credit engagement, clientele, commercial, finance, IT, risk, syndication, and such.

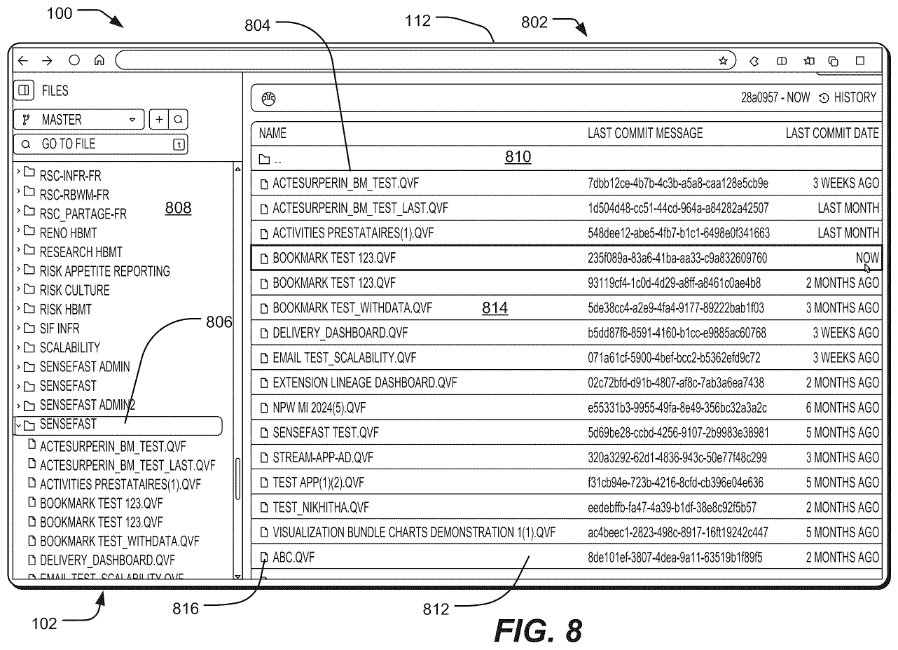

FIG. 8 depicts an example system 100 including the application deployment platform 102. As shown in FIG. 8, the application deployment platform 102 can include an external developer platform interface 802 for implementing the components and operations discussed herein. The system(s) 100 depicted in FIG. 8 can be similar to, identical to, and/or can form at least a portion of the system(s) 100 shown in FIG. 1.

In some examples, the external platform interface 802 can provide access to the application template(s) 804 for the target application 110. For instance, an account can be selected at a first selectable element 806, such as at a side window 808. Then a list of available application templates can be presented in a second window 810 as a list of a plurality of QVF files 812. The plurality of QVF files can include a plurality of rows 814, wherein each row of the plurality of rows includes a filename, a last commit message, and a last commit time or date. A particular QVF file 816 can be selected from the list of the plurality of QFV files, causing that particular QVF file 816 to be imported to the destination stream and/or the destination application. These operations can be performed using the QVF files as templates without application data. Also, responsive to importing one of the QVF files, the application deployment platform 102 can generate and/or present a notification at the GUI 112. This notification can include a timestamp, an event ID number, a moving dashboard name, a user ID, an imported dashboard name, and/or a replaced dashboard name.

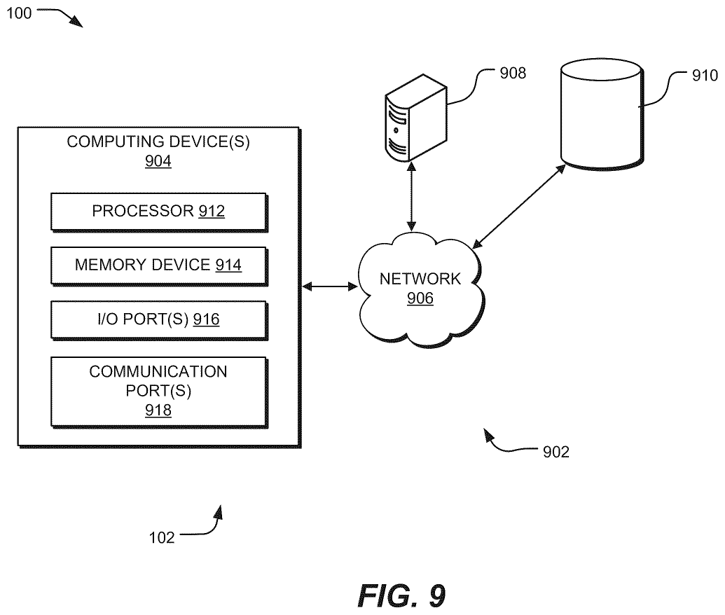

FIG. 9 depicts an example system 100 for implementing the application deployment platform 102 using a networked environment 902 including one or more computing devices 904. The system(s) 100 depicted in FIG. 9 can be similar to, identical to, and/or can form at least a portion of the system(s) 100 shown in FIG. 1.

In some instances, the computing device(s) 904 can include a computer, a personal computer, a desktop computer, a laptop computer, a terminal, a workstation, a cellular or mobile phone, a mobile device, a smart mobile device, a tablet, a wearable device (e.g., a smart watch, smart glasses, a smart epidermal device, etc.), a multimedia console, a television, an Internet-of-Things (IoT) device, a smart home device, a virtual reality (VR) device, an augmented reality (AR) device, and/or the like. It will be appreciated that specific implementations of these devices may be of differing possible specific computing architectures.

In some examples, the computing device(s) 904 discussed herein can communicate via one or more network(s) 906 including any type of network, such as the Internet, an intranet, a Virtual Private Network (VPN), a Voice over Internet Protocol (VoIP) network, a wireless network (e.g., Bluetooth), a cellular network (e.g., 4G, 5G, LTE, etc.), satellite, combinations thereof, etc. The network 906 can include communications network(s) with numerous components such as, but not limited to gateways routers, server(s) 908, and registrars, which enable communication across the network 906. In one implementation, the communications network(s) includes multiple ingress/egress routers, which may have one or more ports, in communication with the network 906. Additionally, or alternatively, the computing device(s) 904 and/or the server(s) 908 can access and be accessed by the network 906 via another type of communications network, which may be a public switched telephone network (PSTN) operated by a local exchange carrier (LEC).

In some instances, at least one server 908 can host a website or application of the application deployment platform 102, such as the web client application 104. The computing device(s) 904 may visit the hosted website to access the application deployment platform 102 and/or to provide inputs to the application deployment platform 102. To perform the operations disclosed herein, the server 908 can access (e.g., read and/or write) one or more database(s) 910. The website or application can receive the inputs and can analyze the inputs to generate outputs for the application deployment platform 102 which can be stored at the database(s) 910. The server 908 may be a single server, a plurality of servers with each such server being a physical server or a virtual machine, or a collection of both physical servers and virtual machines. In another implementation, a cloud service hosts one or more components of the application deployment platform 102. The server(s) 908 may represent an instance among large instances of application servers in a cloud computing environment, a data center, or other computing environment.

Furthermore, the computing device 904 may be a computing system capable of executing a computer program product to execute a computer process. Data and program files may be input to the computing device 904, which reads the files and executes the programs therein. Some of the elements of the computing device 904 can include one or more hardware processors 912, one or more memory devices 914, and/or one or more ports, such as input/output (IO) port(s) 916 and communication port(s) 918. Various elements of the computing device 904 may communicate with one another by way of the communication port(s) 918 and/or one or more communication buses, point-to-point communication paths, or other communication means.

The processor 912 may include, for example, a central processing unit (CPU), a microprocessor, a microcontroller, a digital signal processor (DSP), a graphics processing unit (GPU), and/or one or more internal levels of cache. There may be one or more processors 912, such that the processor 912 comprises a single central-processing unit, or a plurality of processing units capable of executing instructions and performing operations in parallel with each other, referred to as a parallel processing environment.

The computing device 904 may be a single computer, a plurality of computers (e.g., a distributed computer), or another type of computer, such as one or more external computers made available via the cloud computing architecture. The presently described technology is optionally implemented in software stored on a data storage device(s) such as the memory device(s) 914 (e.g., locally stored at the computing device 904), and/or communicated via one or more of the ports 916 or 918 to the application deployment platform 102, thereby transforming the computing device 904 into a special purpose machine for implementing the operations described herein.

The one or more memory device(s) 914 may include any non-volatile data storage device capable of storing data generated or employed within the computing device 904, such as computer executable instructions for performing a computer process, which may include instructions of both application programs and an operating system (OS) that manages the various components of the computing device 904. The memory device(s) 914 may include, without limitation, magnetic disk drives, optical disk drives, solid state drives (SSDs), flash drives, and the like. The memory device(s) 914 may include removable data storage media, non-removable data storage media, and/or external storage devices made available via a wired or wireless network with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 914 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 914 which may be referred to as machine-readable media. It will be appreciated that machine-readable media may include tangible non-transitory medium capable of storing or encoding instructions to perform operations of the application deployment platform 102. The machine-readable media can store computer-readable instructions for execution by a machine, and/or can be capable of storing or encoding data structures and/or modules utilized by or associated with such instructions.

In some implementations, the computing device 904 can include one or more ports, such as the I/O port 916 and the communication port 918, for communicating with other computing, network, or devices. It will be appreciated that the I/O port 916 and the communication port 918 may be combined or separate and that more or fewer ports may be included in the computing device 904.

The I/O port 916 may be connected to an I/O device, or other device, by which information is input to or output from the computing device 904. For instance, input devices can convert a human-generated signal, such as, human voice, physical movement, physical touch or pressure, and/or the like, into electrical signals as input data into the computing device 904 via the I/O port 916. Similarly, output devices may convert electrical signals received from the computing device 904 via the I/O port 916 into signals that may be sensed as output by a human, such as sound, light, and/or touch. The input device may be an alphanumeric input device, including alphanumeric and other keys for communicating information and/or command selections to the processor 912 via the I/O port 916. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, an accelerometer; and/or a touch-sensitive display screen (“touchscreen”). The output devices may include, without limitation, a display, a touchscreen, a speaker, a tactile or haptic output device, and/or the like. In some implementations, the input device and the output device may be the same device, for example, in the case of a touchscreen.

In one implementation, the communication port 918 is connected to the network 906, and the computing device 904 may receive network data useful in executing the methods and systems set out herein as well as transmitting information and network configuration changes determined thereby. Stated differently, the communication port 918 can connect the computing device 904 to one or more communication interface devices configured to transmit and/or receive information between the computing device 904 and other devices by way of one or more wired or wireless communication networks or connections. Examples of such networks connections include, without limitation, Universal Serial Bus (USB), Ethernet, Wi-Fi, Bluetooth®, Near Field Communication (NFC), or any other network connection interface of the network 906. For instance, one or more such communication interface devices may be utilized via the communication port 918 to communicate with one or more other machines, either directly over a point-to-point communication path, over a wide area network (WAN) (e.g., the Internet), over a local area network (LAN), over a cellular network, or over another communication means. Further, the communication port 918 may communicate with an antenna or other link for electromagnetic signal transmission and/or reception.

FIG. 10 depicts example method(s) 1000 of deploying one or more target application(s) 110 using the application deployment platform 102, which can be performed by any of the system(s) 100 disclosed herein.

At operation 1002, the method 1000 can receive, at a GUI of a web client application, one or more user inputs identifying a target application and a plurality of deployment parameters for the target application. At operation 1004, the method can integrate a backend control system with a cloud workflow management platform API, an issue tracking platform API, a source data analytics and management platform API, and a developer platform API. At operation 1006, the method 1000 can perform one or more verification operations, based on the plurality of deployment parameters, and using a plurality of communications between the backend control system and the cloud workflow management platform API; the issue tracking platform API; the source data analytics and management platform API; or the developer platform API. At operation 1008, the method 1000 can, responsive to completion of the one or more verification operations, migrate, using a backend migration system, the target application from a developer platform associated with the developer platform API to a destination environment.

It is to be understood that the specific order or hierarchy of steps in the methods depicted throughout this disclosure are instances of example approaches and can be rearranged while remaining within the disclosed subject matter. For instance, any of the operations discussed throughout this disclosure may be omitted, repeated, performed in parallel, performed in a different order, and/or combined with any other of the operations discussed throughout this disclosure.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. Any component or feature of one example disclosed herein can be combined with any component or feature of any other example disclosed herein. These and other variations, modifications, additions, and improvements may fall within the scope of the disclosure as defined in the claims that follow.

What is claimed is:

1. An application deployment platform comprising:
a web client application providing a graphical user interface (GUI) configured to receive one or more user inputs identifying a target application and a plurality of deployment parameters for the target application;
a backend control system integrated with a cloud workflow management platform API, an issue tracking platform API, a source data analytics and management platform API, and a developer platform API, the backend control system performs one or more verification operations including determining whether the one or more user inputs are associated with an IT personnel or a business unit personnel; and
a backend migration system configured, responsive to completion of the one or more verification operations by the backend control system, to migrate the target application from a developer platform associated with the developer platform API to a destination environment.

2. The application deployment platform of claim 1, wherein,
the GUI includes an environment selection prompt and an application movement prompt.

3. The application deployment platform of claim 2, wherein,
the migrating of the target application includes sending a QVF file without data to the destination environment.

4. The application deployment platform of claim 1, wherein,
the one or more verification operations includes checking, based on a determination of a type of user, whether:
a change request number associated with the IT personnel is valid; or
a Jira ticket number, associated with the business unit personnel is valid.

5. The application deployment platform of claim 1, wherein,
the target application includes a dashboard template.

6. The application deployment platform of claim 1, wherein,
the plurality of deployment parameters indicated by the one or more user inputs includes at least one of a source stream, a source application, a destination stream, or a destination application.

7. The application deployment platform of claim 1, wherein,
the backend control system determines that the one or more user inputs are associated with the IT personnel and, in response, sends an API request to the cloud workflow management platform API.

8. The application deployment platform of claim 1, wherein,
the backend control system determines that the one or more user inputs are associated with the business unit personnel and, in response, sends an API request to the cloud workflow management platform API.

9. The application deployment platform of claim 7, wherein,
the backend control system is configured, responsive to receiving the plurality of deployment parameters, to send a query to a source data analytics and management server associated with the source data analytics and management platform API, for a list of streams for which a user associated with the one or more user inputs is authorized.

10. The application deployment platform of claim 7, wherein,
the backend control system is configured, responsive to receiving the plurality of deployment parameters, to send a query to a source data analytics and management server for a list of streams for which a user associated with the one or more user inputs is authorized.

11. An application deployment platform comprising:
a web client application providing a graphical user interface (GUI) configured to receive one or more user inputs identifying a target application and a plurality of deployment parameters for the target application, the plurality of deployment parameters includes an indication of at least one of a source application, a source stream, a destination application, or a destination stream;
a backend control system integrated with a cloud workflow management platform API, an issue tracking platform API, a source data analytics and management platform API, and a developer platform API, the backend control system performs one or more verification operations including determining whether the one or more user inputs are associated with a user authorized to access the source application, the source stream, the destination application, or the destination stream; and
a backend migration system configured, responsive to completion of the one or more verification operations by the backend control system, to migrate the target application from a developer platform associated with the developer platform API to a destination environment.

12. The application deployment platform of claim 11, wherein,
the migrating of the target application includes identifying a previously uploaded application in the destination environment and replacing the previously uploaded application with the target application.

13. The application deployment platform of claim 11, wherein,
the backend control system is configured to convert a plurality of responses from the source data analytics and management platform API from a plurality of JSON data files to a plurality of pandas data frame files.

14. The application deployment platform of claim 13, further comprising:
a vectorization search performed on the plurality of pandas data frame files.

15. The application deployment platform of claim 11, further comprising:
a token-based authentication between the web client application and the developer platform API.

16. The application deployment platform of claim 11, wherein,
the backend control system is configured to:
receive a fail or error message in response to an API request sent to the cloud workflow management platform API or the developer platform API; and
responsive to the fail or error message, queue the API request for a retry.

17. A method of deploying an application using an application deployment platform, the method comprising:
receiving, at a graphical user interface (GUI) of a web client application, one or more user inputs identifying a target application and a plurality of deployment parameters for the target application;
integrating a backend control system with a cloud workflow management platform API, an issue tracking platform API, a source data analytics and management platform API, and a developer platform API;
performing one or more verification operations, based on the plurality of deployment parameters, and using a plurality of communications between the backend control system and:
the cloud workflow management platform API;
the issue tracking platform API;
the source data analytics and management platform API; or
the developer platform API; and
responsive to completion of the one or more verification operations, migrating, using a backend migration system, the target application from a developer platform associated with the developer platform API to a destination environment.

18. The method of claim 17, wherein,
the plurality of deployment parameters include one or more indications of a source application, a source stream, a destination application, or a destination stream.

19. The method of claim 18, wherein,
the one or more verification operations include:
determining whether a user associated with the one or more user inputs is authorized to access the source application, the source stream, the destination application, and the destination stream; or
determining whether the one or more user inputs are associated with an IT personnel or a business unit personnel.

20. A method of claim 17, further comprising:
presenting, at the GUI:
a first selectable interface element configured to receive a first user input indicating a deployment environment;
a second selectable interface element configured to receive a second user input indicating a source server;
a third selectable interface element configured to receive a third user input indicating a destination server;
a fourth selectable interface element configured to receive a fourth user input indicating a source stream; and
a fifth selectable interface element configured to receive a fifth user input indicating a destination stream.
